(19) United States
(12) Patent Application Publication
(10) Pub. No.: US 2015/0210868 A1
(43) Pub. Date: Jul. 30, 2015

(54) METHOD FOR SYNTHESIZING NANOPARTICLES ON SURFACES

(71) Applicant: NORTHWESTERN UNIVERSITY, Evanston, IL (US)

(72) Inventors: Chad A. Mirkin, Wilmette, IL (US); Guoliang Liu, Evanston, IL (US); Daniel J. Eichelsdoerfer, Evanston, IL (US); Keith A. Brown, Evanston, IL (US)

(21) Appl. No.: 14/419,360

(22) PCT Filed: Sep. 6, 2013
(86) PCT No.: PCT/US2013/058507

§ 371 Date: Feb. 3, 2015

Related U.S. Application Data
(60) Provisional application No. 61/699,076, filed on Sep. 10, 2012.

(51) Int. Cl. C09D 11/10; B05D 1/02; C08K 3/22; B05D 1/18; B05D 1/28; B05D 3/00; B05D 1/00

(52) U.S. Cl. CPC C09D 11/10; B05D 3/007; B05D 1/02; B05D 1/005; B05D 1/18; B05D 1/28; C08K 3/22

(57) ABSTRACT

A method of forming a nanostructure on a substrate surface can include heating a substrate comprising a composition comprising a block copolymer and a nanostructure precursor to a temperature above the glass transition temperature of the block copolymer and below the decomposition temperature of the block copolymer to aggregate the nanostructure precursor to form a nanostructure precursor aggregated composition. The method can further include heating the nanostructure precursor aggregated composition to a temperature above the decomposition temperature of the nanostructure precursor to decompose the polymer and form the nanostructure.

### STATEMENT OF GOVERNMENTAL INTEREST

The invention was made with government support under grant number N66001-08-1-2044 awarded by the Department of Defense, Defense Advanced Research Projects Agency (DARPA) and grant number N00244-09-0012 awarded by the Department of Defense, National Security Science and Engineering Faculty Fellowships (NSSEFF). The government has certain rights in this invention.

### BACKGROUND

1. Field of the Disclosure

The disclosure is generally directed to a patterning method, and more particularly, to a method of synthesizing and patterning structures using block copolymer assisted patterning.

2. Brief Description of Related Technology

The integration of nanoparticles into devices has enabled applications spanning sensing (1, 2), catalysis (3), electronics (2), photonics (4), and plasmonics (5, 6), but synthesizing individual nanoparticles with control over size, composition, and placement on substrates is challenging (1-3, 6, 7). With conventional approaches, nanoparticles are synthesized and subsequently positioned on a surface using techniques such as parallel printing (8), surface dewetting (9, 10), microdroplet molding (7), direct writing (4, 11), and self-assembly (2, 12-14). However, it is difficult, and in most cases impossible, to use these methods to reliably make and position a single particle on a surface with nanometer scale control.

Recently, scanning probe block copolymer lithography has emerged as a tool for synthesizing nanoparticles from high mobility precursors (15, 16), but it is extremely limited from a materials standpoint.

The challenge of positioning or synthesizing single sub-10 nm nanoparticles in desired locations can be difficult, if not impossible, to achieve using currently available techniques including conventional photolithography. Current lithographic methods produce nanoparticle arrays through either lift-off processes or by prepatterning the surface chemically or geometrically to assist in the assembly of nanoparticles.

Although techniques such as electron beam (e-beam) lithography offer sub-50 nm resolution, fabricating sub-10 nm features can be difficult because of proximity effects resulting from electron beam-photoresist interactions. Additionally, the throughput of e-beam lithography is limited by its serial nature. Nanoimprint lithography and micro-contact printing, on the other hand, afford parallel patterning, but do not allow for arbitrary pattern formation. As scanning probe based methods, dip pen nanolithography (DPN) and polymer pen lithography (PPL) are particularly attractive because “inked” nanoscale tips can deliver material directly to a desired location on a substrate of interest with high registration and sub-50 nm feature resolution. These versatile techniques have been used to generate nanopatterns of alkanethiols, oligonucleotides, proteins, polymers, and inorganic materials on a wide variety of substrates. Previous attempts have been made to pattern nanoparticles directly by DPN, but the strong dependence of this technique on surface interactions, tip inking, and ink transport resulted in inhomogeneous features, whereas nanoparticle assembly via DPN-generated templates are inherently indirect and not ideal for positioning single objects with sub-10 nm dimensions. Because feature resolution is limited by the AFM tip radius of curvature and the water meniscus formed between tip and substrate, the ultimate resolution of DPN reported to date is 12 nm for an alkanethiol feature formed on crystalline Au (111) substrate, which was achieved by using an ultra sharp tip with a 2 nm radius.

In contrast with top-down approaches, the self-assembly of block copolymers offers a versatile platform, which affords feature sizes typically in the range of 5 nm to 100 nm, as dictated by the molecular weight of the block copolymers. The well-defined domain structures of the block copolymer system can be used as templates to achieve secondary patterns of functional materials including metals, semiconductors, and dielectrics. However, previous work described the use of block copolymers as thin film templates for the synthesis of nanoparticle arrays in mass, without control over individual particle position or dimensions. These phase separated domains often lack orientation and long-range order, preventing widespread use and adoption in technologically relevant applications. Attempts to improve ordering in block copolymer systems have been explored using external electric fields, shear and flow stresses, thermal gradients, solvent annealing, chemical prepatterning, and graphoepitaxy. Chemical prepatterning and graphoepitaxy provide more control over translational order and feature registration in patterns, but require additional indirect lithographic steps, such as e-beam lithography, which is expensive and low throughput for large area applications. Quasi-long range order of block copolymer microdomains on corrugated crystalline sapphire surfaces was obtained without the use of additional lithographic steps. This technique, however, is limited in the type of substrate that can be patterned and does not allow for positional control of the particles on arbitrary surfaces.

### SUMMARY

In accordance with an embodiment of the disclosure, a method for forming a structure on a substrate surface that includes contacting a substrate with a tip coated with a composition comprising a block copolymer and a structure precursor to form a printed feature comprising the block copolymer and the structure precursor on the substrate. The method further includes heating the printed feature to a temperature below a decomposition temperature of the block copolymer to aggregate the nanostructure precursor and form a structure precursor aggregated printed feature. Optionally the temperature can be above a glass transition temperature of the block copolymer. The method also includes heating the structure precursor aggregated printed feature to a temperature above the decomposition temperature of the structure precursor to decompose the polymer, thereby forming the structure. In various aspects, the structures are sub-micron sized nanostructures.

In accordance with an embodiment of the disclosure, a method of forming a structure on a substrate surface, includes heating a substrate comprising a composition comprising a block copolymer and a structure precursor to a temperature below the decomposition temperature of the block copolymer to aggregate the structure precursor to form a structure precursor aggregated composition. The temperature can optionally be above the glass transition temperature of the block copolymer. The method further includes heating the structure precursor aggregated composition to a temperature above the decomposition temperature of the structure precursor to decompose the polymer and form the structure. In various aspects, the structures are sub-micron sized nanostructures.

### BRIEF DESCRIPTION OF THE DRAWINGS

FIG. 1a is a schematic illustration of a method for forming a nanoparticle in accordance with embodiments of the disclosure;

FIG. 1b is a temperature profile of first and second thermal treatments of a method of forming a nanoparticle in accordance with embodiments of the disclosure;

FIG. 2a is a scanning electron microscopy (SEM) image of large-area patterned nanoreactors loaded with gold precursors on a hydrophobic silicon substrate;

FIG. 2b is an atomic force microscopy image of a patterned array of nanoreactors, the diameters of which are 400 nm;

FIG. 2c are ex-situ SEM images illustrating diffusion and segregation of gold precursors inside the polymer matrix during a method of forming nanoparticles in accordance with an embodiment of the disclosure;

FIG. 2d is an SEM image of an array of synthesized gold nanoparticles on a hydrophobic silicon substrate and a magnified view of a single gold nanoparticle, the dashed circle denotes the original size of the nanoreactor;

FIG. 2e is an SEM image illustrating that multiple nanoparticles are formed when the first thermal treatment step is eliminated, the dashed circle denotes the original size of the nanoreactor;

FIG. 3a is a schematic illustration of the pathways for formation of a nanoparticle using methods in accordance with embodiments of the disclosure, Mⁿ⁺ and M⁰ denote metal ions and fully reduced metal, respectively. Δ₁ and Δ₂ correspond to the first and second thermal treatments at T_{row} and T_{high}, respectively;

FIG. 3b are XPS spectra collected for exemplary precursors for each pathway before thermal treatment (top), after the first thermal treatment (middle), and after the second thermal treatment (bottom). All spectra are shifted for clarity and the dashed lines denote the initial and final peak positions;

FIGS. 4a and 4b are high-angle annular dark-field (HAADF) STEM (z-contrast) images of Pt nanoparticle synthesis in accordance with an embodiment of the disclosure. After the first thermal treatment (FIG. 4a) the precursor, H₂PtCl₆ aggregated within the polymer nonreactor. After the second thermal treatment (FIG. 4b), the precursor decomposed and formed a single nanoparticle. The polymer nanoreactors were also decomposed. The dashed circles outline the boundary of the polymer nanoreactors;

FIG. 5 is HRTEM images illustrating the cyrstallinity of nanoparticles form in accordance an embodiment of the disclosure;

FIGS. 6a and 6b are TEM images of a patterned array of PEO-b-P2VP nanoreactors on hydrophobic silicon nitride window after the first thermal treatment at 150° C. (FIG. 6a) and after the second thermal treatment at 500° C. (FIG. 6b). Ag nanoparticles were observed after the first annealing step. The dotted circles denote the position of the patterned printed features (nanoreactors);

FIG. 7 is an EDX spectra of synthesized metal nanoparticles formed in accordance with a method in accordance with the disclosure. Si signal is from the silicon nitride membrane. Al and Cu signals are from the TEM sample holder. Since a Cu signal is always present in the background, an EDX spectrum of Cu-containing nanoparticles is not shown;

FIG. 8 is an XPS spectra of nanoparticles composed of Ag, Pd, Co₂O₃, NiO, and CuO after formation using a method in accordance with an embodiment of the disclosure;

FIG. 9 is a graph of a thermogravimetric analysis of PEO-b-P2VP illustrating that the thermal decomposition peak of PEO-b-P2VP is at 409° C. The temperature ramping rate was 10° C./min

FIG. 10 is HRTEM images of gold nanoparticles formed by a method in accordance with an embodiment of the disclosure with the size of the nanoparticle being controlled by the concentration of the nanostructure precursor in the block-copolymer nanostructure precursor ink;

FIG. 11 is TEM images of patterned arrays of nanoreactors of PEO-b-P2VP on a silicon nitride window after the first thermal treatment illustrating the effect of protonation of PEO-b-P2VP on the loading of the precursors;

FIG. 12a is a photograph of HAuCl₄ in PEO-b-P2VP aqueous solution (Au^{III}:2VP=4.1) after 1 day and 14 days illustrating the reduction of Au^{III} to Au⁰ and formation of Au nanoparticles in the solution after 14 days;

FIG. 12b is an SEM image of representative Au nanoparticles formed in solution after 14 days; and

FIG. 13 is representative STEM images of arrays of nanoparticles for precursors having varying reduction potentials. Dotted circles highlight the position of nanoparticles. For clarity, zoomed-in images of nanoparticles are shown in the inset. The scale bars apply to all images and inset images. The difference size of the nanoparticles are determined by the ink concentration and amount of polymer delivered to the synthesis sites.

### DETAILED DESCRIPTION

The methods disclosed herein can allow for patterning of sub-10 nm size single nanostructures, for example, nanoparticles, while enabling one to control the growth and position of individual nanostructures in situ. The methods can also allow for patterning of larger structures, for example, up to 100 nm sized structures. The process is advantageously based on an understanding of the pathways for polymer-mediated and can allow for the generation of single nanoparticles of a variety of materials, including, for example, metals, metal oxides, or metal alloys, independent of precursor mobility. Nanoparticles exhibit size-dependent photonic, electronic, and chemical properties that could lead to a new generation of catalysts and nanodevices, including single electron transistors, photonics, and biomedical sensors.

In order to realize many of these targeted applications, the methods of the disclosure can advantageously provide for the synthesis of monodisperse particles while controlling individual particle position on technologically relevant surfaces. The method of the disclosure allows for a materials general approach to synthesizing individual nanoparticles as well as nanostructures with control over size, composition, and surface placement, thereby allowing for the synthesis of a diverse class of nanoparticles and structures, including, for example, Au, Ag, Pt, Pd, Fe₂O₃, Co₂O₃, NiO, CuO, and alloys of Au and Ag. The methods of the disclosure can advantageously provide simple and materials general method for synthesizing nanostructures with tailored size, composition, and placement. The nanostructures can be synthesized on site and can be rapidly integrated into functional devices, with, in some embodiments, no need for post-synthetic processing or assembly. The ability to synthesize homogenous or combinatorial arrays of specified nanoparticles on surfaces can enable fundamental studies and technological applications in fields such as catalysis, nanomagnetism, microelectronics, and plasmonics. The understanding of polymer-mediated nanoparticle synthesis can also enable the utilization of block copolymers as a matrix to synthesize three dimensional nanoparticle lattices, both in thin films and in the bulk.

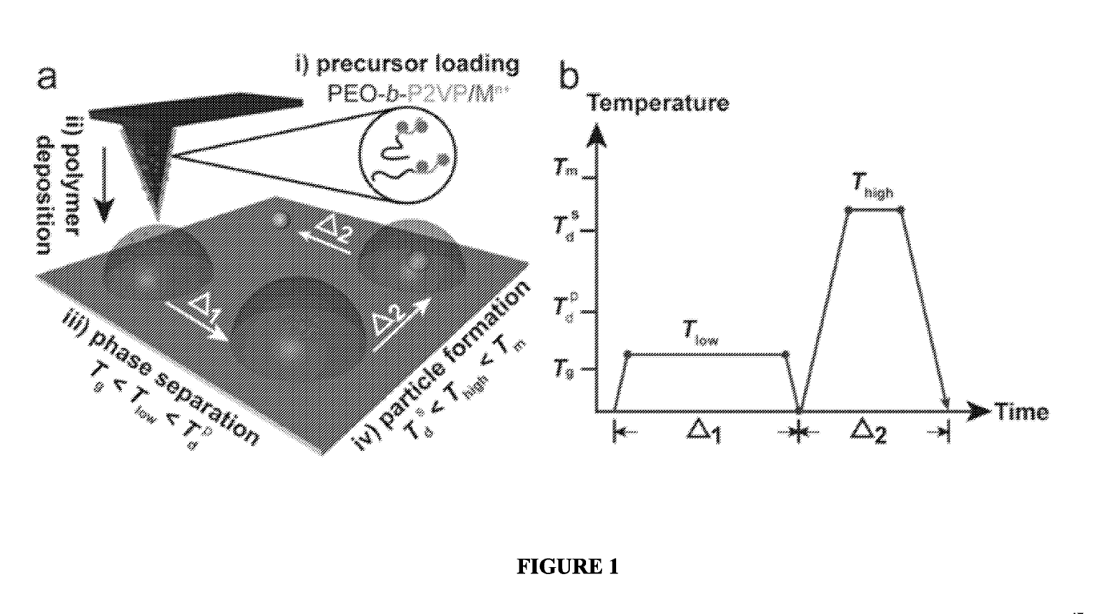

In accordance with embodiments of the disclosure, the method can utilize dip-pen nanolithography or polymer pen lithography printing methods to transfer block copolymer-nanostructure precursor inks to a substrate. “Block copolymer-nanostructure precursor inks” and block copolymer structure precursor inks” are used herein interchangeable and refer to an ink or coating composition for patterning or coating a substrate that includes a block copolymer and a precursor. In alternative embodiments, an ink containing the block copolymer and structure precursor can be applied to a substrate using any know non-tip based method, such as micro-contact printing, dip coating, spin coating, vapor coating, spray coating, and brushing. FIG. 1A is a schematic illustration of a method in accordance with the disclosure, exemplifying application of the block copolymer-structure precursor ink using dip-pen nanolithography.

As illustrated in FIG. 1, after application of the block copolymer-structure precursor ink to a substrate (whether by tip-based or non-tip based application methods), structure formation can be induced by thermal annealing. In one embodiment, a first thermal treatment Δ1 is performed in which the applied ink can be annealed at temperature T_{low} that is above the decomposition temperature T^{P}_{d} of the polymer. Optionally, the temperature T_{low} can be between the glass transition temperature T_{g} of the polymer and the decomposition temperature T^{P}_{d} of the polymer (T_{g}<T_{low}<T^{P}_{d}). The first thermal treatment initiates phase separation and aggregation of the nanoparticle precursor materials within the printed feature or coating. In various embodiments, as detailed below, structure precursor ion reduction can occur during the first thermal treatment. Subsequently, a second thermal treatment Δ2 can be performed at a temperature T_{high} at a temperature above the decomposition temperature of the structure precursor T^{S}_{d}. Optionally the temperature T_{high} can be between the decomposition temperature of the structure precursor T^{S}_{d} and the melting point of the structure precursor T^{m} (T^{S}_{d}<T_{high}<T^{m}) to facilitate one or more of nanostructure precursor ion reduction, particle formation, and polymer decomposition. FIG. 1B is a schematic illustration of the heating profiles of the first and second thermal treatments.

The methods of the disclosure advantageously utilize polymer-mediated diffusion of the structure precursor within the block copolymers. The block copolymer can acts as a transport vehicle for precursor deposition, a diffusion media for structure precursor aggregation, a reducing agent for precursor reduction, and/or a spatially confined nanoreactor for particle synthetic reactions. In an embodiment, the block copolymer sequentially acts as a transport vehicle for precursor deposition, a diffusion media for structure precursor aggregation, a reducing agent for precursor reduction, and a spatially confined nanoreactor for particle synthetic reactions.

The block copolymer matrix can then be removed. The printed features and accordingly the formation of the structures can be arranged in any arbitrary pattern using the method of the disclosure. Any structure having any shape can be formed by the method of the disclosure. The nanostructures can be, for example, nanoparticles or nanowires.

Advantageously, methods in accordance with embodiments of the disclosure can allow for synthesis of nanostructures having a size 10 or more times smaller than the originally printed features. For example, the printed features, which include the block-copolymer matrix and the nanostructure precursor, can have a diameter or line width of about 20 nm to about 1000 nm, about 40 nm to about 800 nm, about 60 nm to about 600 nm, about 80 nm to about 400 nm, or about 100 nm to about 200 nm. Other suitable printed feature diameters or line widths include about 20, 30, 40, 50, 60, 70, 80, 90, 100, 110, 120, 130, 140, 150, 160, 170, 180, 190, 200, 220, 240, 260, 280, 300, 320, 340, 360, 380, 400, 420, 440, 460, 480, 500, 520, 540, 560, 580, 600, 620, 640, 660, 680, 700, 720, 740, 760, 780, 800, 820, 840, 860, 880, 900, 920, 940, 960, 980, and 1000 nm. The resulting nanostructures can have a diameter or line width of about 1 nm to about 100 nm, about 1 nm to about 25 nm, about 2 nm to about 20 nm, about 4 nm to about 15 nm, about 6 nm to about 10 nm, about 50 nm to about 80 nm, or about 40 nm to about 60 nm. Other suitable nanostructure diameters or line widths include, for example, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, and 100 nm.

Referring to FIG. 1A, a method of forming nano structures can include loading a tip with the ink that includes a block copolymer matrix and a nanostructure precursor. FIG. 1A illustrates the use of a dip-pen nanolithography (DPN) tip for patterning. However, other tip-based lithography methods, such as polymer pen lithography (PPL) and gel pen lithography, can be used. The coated tip is then brought into contact with a substrate to deposit the ink on the substrate in the form of printed features. Embodiments of the method of the disclosure can allow for arbitrary pattern control of single nanostructures, for example, nanoparticles, by patterning with tip-based patterning methods such as DPN and PPL.

Alternatively, non-tip based coating and patterning methods can be used. Non-tip based methods can include any known application methods including, but not limited to, micro-contact printing, dip coating, spin coating, vapor coating, spray coating, brushing, and combinations thereof.

As used herein “printed features,” generally refers to features patterned by both tip-based and non-tip based patterning methods as well as coatings applied to a substrate. The printed features include the block copolymer matrix, which is also referred to herein as a nanoreactor, and the structure precursor contained in the block copolymer matrix.

The block copolymer material should be selected so as to be capable of sequestering the structure precursor. In various embodiments in which tip-based patterning methods are used, the block copolymer should also be selected so as to be capable of transferring from a scanning probe tip to a substrate in a controllable way. Suitable block copolymer materials include, for example, poly(ethylene oxide)-b-poly(2-vinylpyridine) (PEO-b-P2VP), PEO-b-P4VP, and PEO-b-PAA. FIG. 1A illustrates the PEO-b-P2VP block copolymer. When using a PEO-b-P2VP block copolymer, the P2VP is responsible for concentrating the nanostructure precursor, while the PEO acts as a delivery block to facilitate ink transport. The block copolymer can separate into micelles, for example, nanoscale micelles, upon patterning or coating, which can facilitate localizing the structure precursor.

The molar ratio of the nanostructure concentrating or precursor-coordinating block to the structure precursor can be about 1:0.1 to about 300:1, about 1:0.1 to about 10:1, about 1:0.5 to about 8:1, about 1:1:to about 10:1, about 2:1 to about 8:1, about 4:1 to about 6:1, about 10:1 to about 64:1, about 15:1 to about 60:1, about 30:1 to about 40:1, about 2:1 to about 256:1, about 10:1 to about 200:1, about 20:1 to about 150:1, about 30:1 to about 100:1, about 40:1 to about 50:1, about 100:1 to about 256:1, about 80:1 to about 200:1, about 60:1 to about 100:1, about 2:1 to about 4:1, about 2:1 to about 25:1, about 6:1 to about 20:1, about 10:1 to about 40:1, or about 25:1 to about 75:1. Other suitable molar ratios include about 1:0.1, 1:0.2, 1:0.25, 1:0.3, 1:0.4, 1:0.5, 1:0.6, 1:0.7, 1:0.8, 1:0.9, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 22:1, 24:1, 26:1, 28:1, 30:1, 32:1, 34:1, 36:1, 38:1, 40:1, 42:1, 44:1, 46:1, 48:1, 50:1, 52:1, 54:1, 56:1, 58:1, 60:1, 62:1, 64:1, 65:1, 70:1, 75:1, 80:1, 85:1, 90:1, 100:1, 120:1, 140:1, 160:1, 180:1, 190:1, 200:1, 210:1, 220:1, 230:1, 240:1, 250:1, and 256:1.

The structure precursor can be, for example, any precursor material suitable for forming a metal nanostructure, a semiconductor nanostructure, or a dielectric nanostructure, as well as larger feature sized metal, semiconductor, and dielectric structures. For example, the structure precursor can be a metal salt, such as, of HAuCl₄, AgNO₃, H₂PtCl₆, Na₂PdCl₄, Fe(NO₃)₃, Co(NO₃)₂, Ni(NO₃)₂, Cu(NO₃)₂, Na₂PtCl₄, CdCl₂, ZnCl₂, FeCl₃, NiCl₂, and combinations thereof. In one embodiment, metal alloy structures can be formed by blending metal precursors in the ink. For example, metal alloy nanoparticles can be formed by blending metal precursors in the ink.

In one embodiment, when the block copolymer and the structure precursor are mixed in an aqueous solution, micelles with a water insoluble P2VP core surrounded by a PEO corona form, confining the structure precursor, for example, AuCl₄⁻, to the P2VP core.

The block copolymer-structure precursor ink can be printed on or applied to any suitable substrate, including, for example, Si/SiOx substrates, Si₃N₄ membranes, glassy carbon, and Au substrates.

After patterning, a first thermal treatment Δ1 is performed to effect structure precursor ion aggregation. Phase separation during the first thermal treatment Δ1 can concentrate the precursor ions in a single or concentrated region, which for example can enable formation of single structures in each printed feature. In an embodiment, this concentration enables formation of a single nanoparticle. The first thermal treatment is carried out at a temperature T_{low} that is below the decomposition temperature T^{P}_{d} of the polymer. Optionally the temperature T_{low} can be above the glass transition temperature T_{g} of the polymer. For example, depending on the block copolymer used, the temperature T_{low} of first thermal treatment can performed at a temperature T_{low} in a range of about 70° C. to about 400° C., about 78° C. to about 400° C., about 80° C. to about 350° C., about 100° C. to about 300° C. about 120° C. to about 250° C., about 140° C. to about 225° C., about 150° C. to about 200° C., about 70° C. to about 78° C., about 76° C. to about 80° C., or about 78° C. to about 200° C. Other suitable temperatures include for example, about 70, 72, 74, 76, 78, 80, 82, 84, 86, 88, 90, 92, 94, 96, 98, 100, 110, 120, 130, 140, 150, 160, 170, 180, 190, 200, 210, 220, 240, 250, 260, 270, 280, 290, 300, 310, 320, 330, 340, 350, 360, 370, 380, 390, or 400° C. For example, when a PEO-b-P2VP block copolymer is used, the thermal treatment can be performed at a temperature T_{low} of about 150° C. The glass transition temperature of PEO is about −76° C., the glass transition temperature of P2VP is about 78° C., and the decomposition temperature of PEO-b-P2VP is about 400° C. Other suitable temperatures can be used depending on the decomposition temperature of the polymer T^{P}_{d} and/or optionally the glass transition temperature of the polymer T_{g}. The thermal treatment can be performed, for example, in a tube furnace under a flow of Ar gas. In one embodiment, the substrate containing the printed feature can be placed in a furnace and the temperature can be ramped up to T_{low} from ambient temperature in about one hour. The ramping rate for reaching the temperature T_{low} of the first thermal treatment can be, for example, about 1° C./min to about 10° C./min, about 2° C./min to about 8° C./min, about 4° C./min to about 6° C./min, or about 3° C./min to about 7° C./min. Other suitable ramping rates include about 1, 2, 3, 4, 5, 6, 7, 8, 9, and 10° C./min. The first thermal treatment Δ1 can be carried out at the temperature T_{low} for about 2 hours to about 24 hours, about 4 hours to about 24 hours, about 6 hours to about 22 hours, about 8 hours to about 20 hours, about 10 hours to about 18 hours, about 14 hours to about 16 hours and about 2 hours to about 6 hours. Other suitable times include about 2, 3, 4, 5, 6, 7, 8, 9, 10, 12, 14, 16, 18, 20, 22, or 24. The first thermal treatment Δ1 can be carried out for any suitable time to allow for full phase separation between the precursor and the polymer.

The printed features can then be cooled to ambient temperature prior to performing the second thermal treatment. For example, the temperature of the furnace can be cooled to ambient temperature in one hour.

Once the first thermal treatment for effecting nanostructure precursor ion aggregation is complete, a second thermal treatment Δ2 at a temperature T_{high} can be performed. The second thermal treatment can allow for reduction of the precursor and/or decomposition of the polymer. The temperature T_{high} is above the thermal decomposition T^{S}_{d} of the nanostructure precursor material and preferably below the melting point of the precursor T^{m}. For example, depending on the nanostructure precursor, the temperature T_{high} can be in a range of about 400° C. to about 800° C., about 450° C. to about 750° C., about 500° C. to about 700° C., about 550° C. to about 650° C. For example, the temperature can be about 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, and 800° C. Other suitable temperatures can be used depending on the decomposition and melting temperatures of the precursor used. The second thermal treatment Δ2 can be performed in a furnace, for example, a tube furnace under Ar gas. The second thermal treatment Δ2 can be performed, for example, by ramping the temperature of the furnace from ambient to the temperature T_{high} of the second thermal treatment Δ2. For example, the temperature can be ramped to the second thermal treatment temperature T_{high} in one hour. The ramping rate for reaching the temperature T_{high} of the second thermal treatment can be, for example, about 1° C./min to about 10° C./min, about 2° C./min to about 8° C./min, about 4° C./min to about 6° C./min, or about 3° C./min to about 7° C./min. Other suitable ramping rates include about 1, 2, 3, 4, 5, 6, 7, 8, 9, and 10° C./min. The second thermal treatment Δ2 can be performed for about 2 hours to about 10 hours, about 4 hours to about 8 hours, about 6 hours to about 10 hours, about 2 hours to about 4 hours, or about 3 hours to about 7 hours. Other suitable times include about 2, 3, 4, 5, 6, 7, 8, 9, and 10 hours. The second thermally treated substrate can then be cooled for example by ramping the furnace from the temperature T_{high} to ambient temperature.

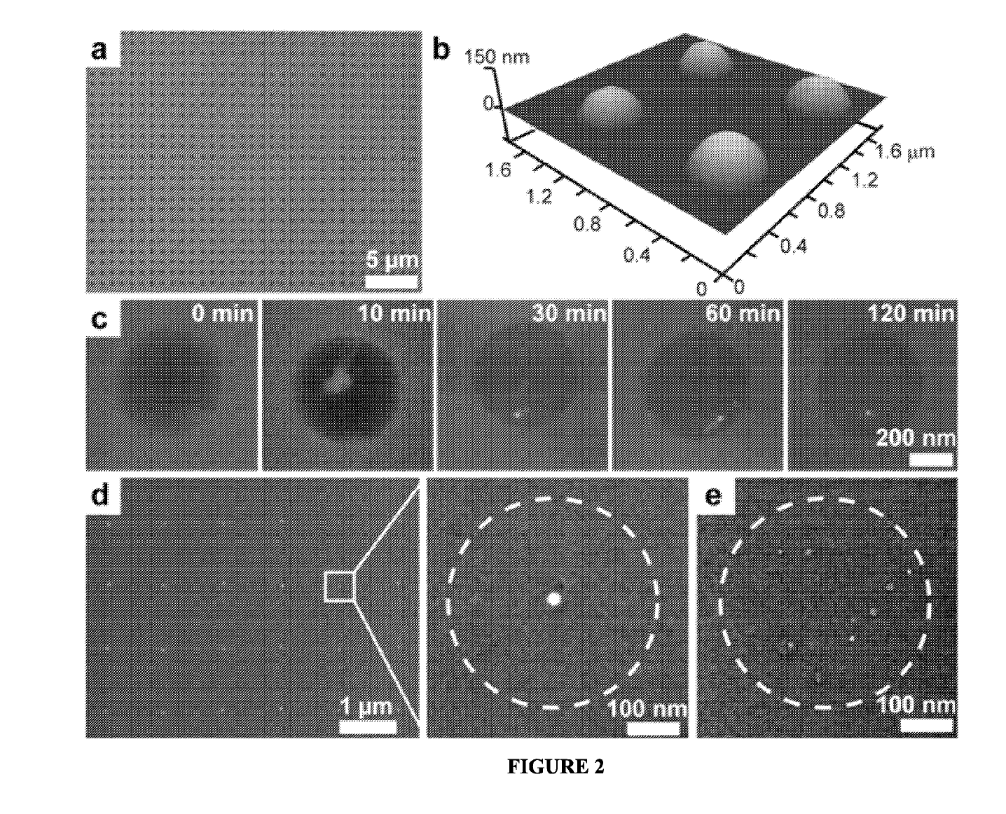

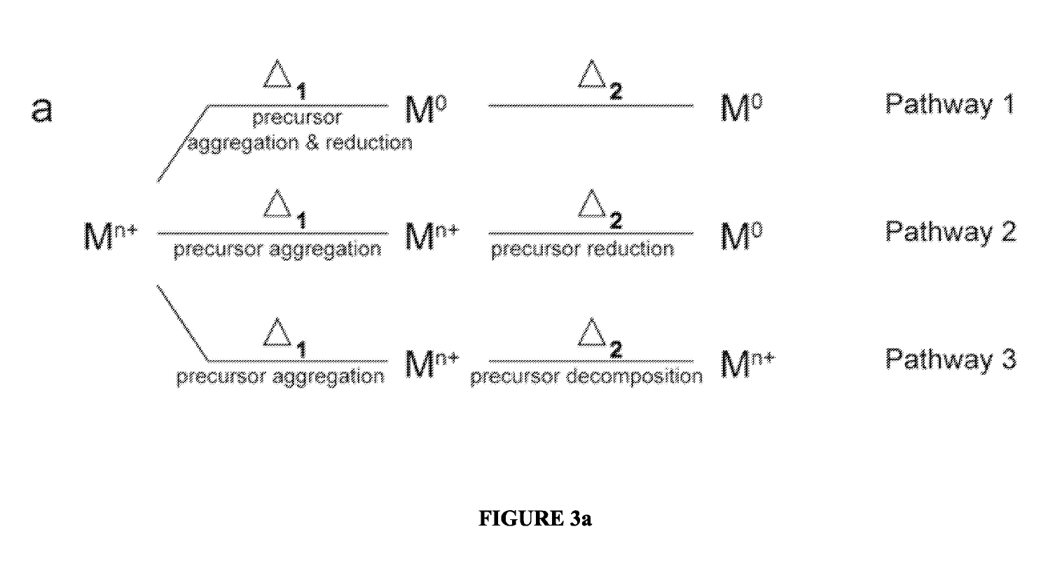

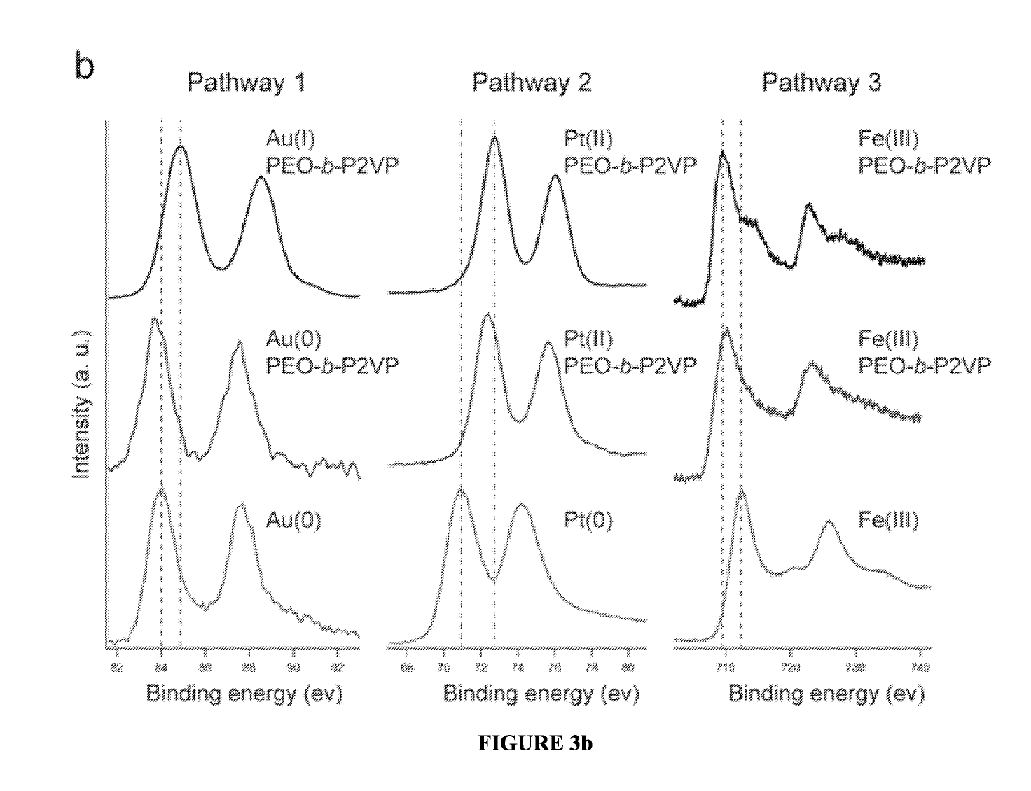

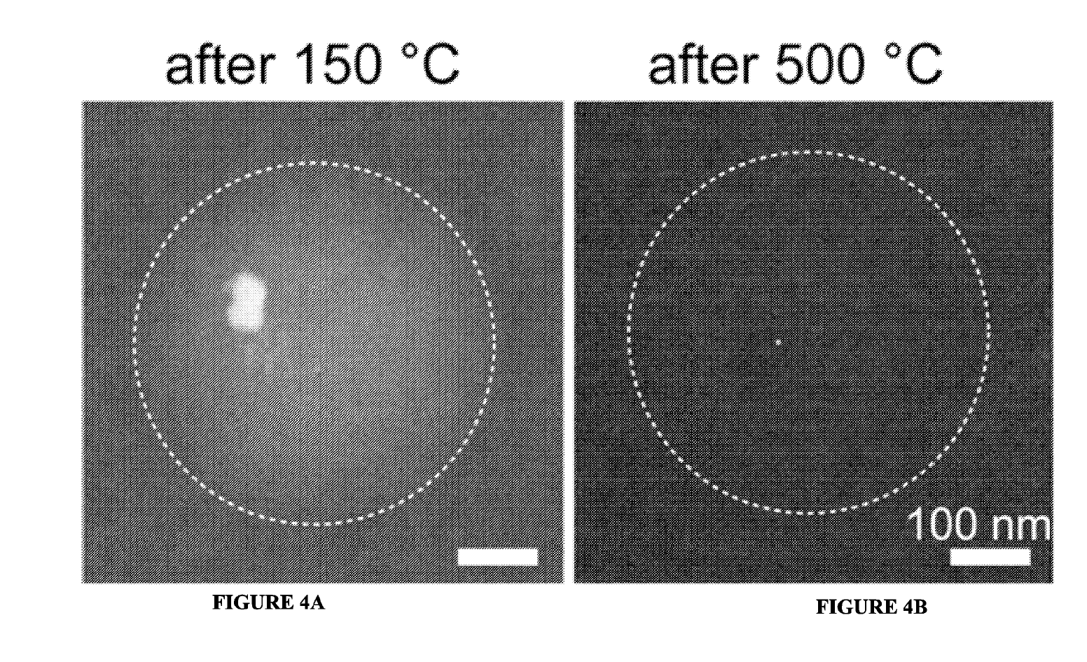

Referring to FIG. 3, it has advantageously been determined that the structure formation process, for example nanoparticle formation, can proceed in at least three different pathways. The structure formation process was investigated by ex-situ scanning electron microscopy (SEM) with respect to formation of nanoparticles. FIG. 2a illustrates a pattern of printed features with polymer nanoreactors loaded with gold precursors. FIG. 2b illustrates an AFM image of a patterned array of printed features having diameters of about 400 nm. Referring to FIG. 2c, this allows for the monitoring of the polymer nanoreactors at various time points during annealing. FIG. 2c was generated using an Au precursor in a PEO-bP2VP polymer matrix. As illustrated in FIG. 2c, as the Au precursor phase separates inside the polymer matrix and forms an aggregate; the even contrast is attribute to a homogeneous metal ion distribution. As illustrated in panel 2 of FIG. 2c, during particle formation, there is a transition to a more heterogeneous appearance with one bright area being attributable to a localized concentration of metal ions. Because PEO is a weak reducing agent, further annealing at T_{low} was performed to reduce the Au precursor and form an Au seed.

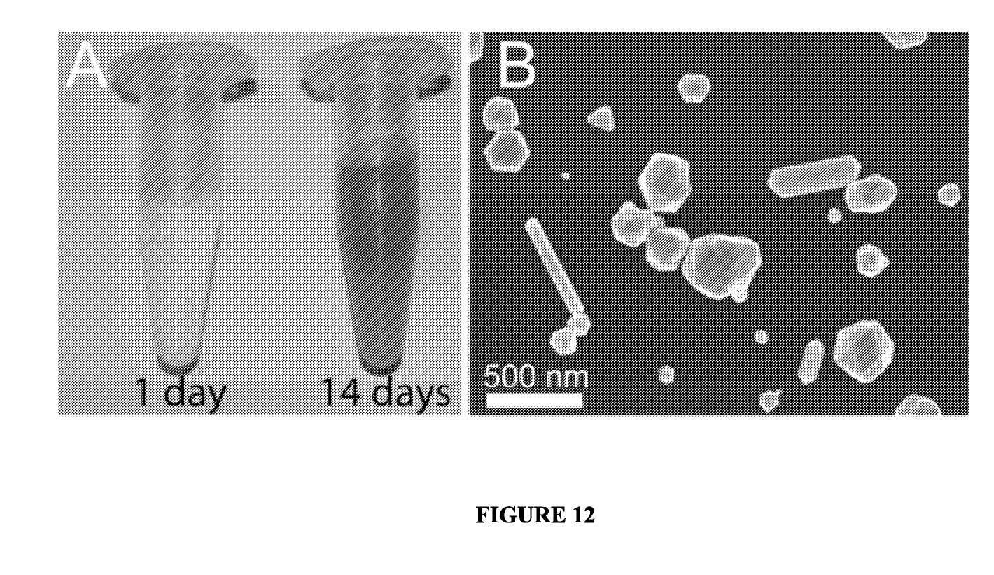

FIG. 12 illustrates that weakly reducing nature of PEO. FIG. 12a is a photograph of HAuCl₄ in PEO-b-P2VP aqueous solution (Au^{III}: 2VP=4:1) after 1 day and 14 days. After 1 day, the Au^{III} was not yet reduced and was yellow in color. After 14 days, the solution changed to dark red, indicating the reduction of Au^{III} to Au⁰ and the formation of Au nanoparticles in solution. The ratio Au:2VP was selected to highlight the color change in the exemplification of FIG. 12a. FIG. 12b is an SEM image of representative Au nanoparticles formed in the solution of FIG. 12a after 14 days. The nanoparticles have various shapes and sizes. In inks containing high reduction potential precursor materials, like Au and Ag, it can be advantageous to use such inks within three days of preparation to avoid reduction of the precursor in the ink solution.

After annealing at T_{low} for a sufficient time the Au precursor can be fully reduced and a single nanoparticle can be formed inside each polymer nanoreactor. FIG. 2d illustrates an array of synthesized gold nanoparticles on a hydrophobic silicon substrate and a magnified view of a single gold nanoparticle, formed by methods in accordance with the disclosure. The dashed circle in the inset of FIG. 2d illustrates the original size of the printed feature prior to thermal treatment and removal of the polymer nanoreactor.

For a nanoparticle that is formed by reduction of the precursor material, the precursor is either reduced by the polymer or through its thermal decomposition depending on the reduction potential of the precursor. For example, depending on the reduction potential of the precursor, the precursor can either be reduced by the polymer when annealed during the first thermal treatment at temperature T_{low} (pathway 1) or during the second thermal treatment during T_{high} (pathway 2). FIG. 2c illustrates an example of pathway 1. In other embodiments, the nanoparticle can have the same oxidation state as the precursor after the first and second thermal treatments (pathway 3). Standard reduction potentials of various precursor materials are provided in Table 1, below.

TABLE 1
Standard Reduction Potential of Precursor Materials

| | |
|---|---|
| Half Reaction | E ° (Volts) |

| | | |
|---|---|---|
| AuCl₄⁻(aq) + 3e⁻ | → Au(s) + 4Cl⁻(aq) | E ° = 1.00 |
| Ag⁺ + e⁻ | → Ag(s) | E ° = 0.80 |
| Fe³⁺ + e⁻ | → Fe²⁺ | E ° = 0.77 |
| [PtCl₄]²⁻(aq) + 2e⁻ | → Pt(s) + 4Cl⁻(aq) | E ° = 0.73 |
| [PtCl₆]²⁻(aq) + 2e⁻ | → [PtCl₄]²⁻(aq) + 2Cl⁻(aq) | E ° = 0.68 |
| [PdCl₄]²⁻(aq) + 2e⁻ | → Pd(s) + 4Cl⁻(aq) | E ° = 0.59 |
| Cu²⁺ + 2e⁻ | → Cu(s) | E ° = 0.34 |
| 2H⁺ + 2e⁻ | → H₂(g) | E ° = 0.00 |
| Ni²⁺ + 2e⁻ | → Ni(s) | E ° = −0.25 |
| Co²⁺ + 2e⁻ | → Co(s) | E ° = −0.28 |
| Fe²⁺ + 2e⁻ | → Fe(s) | E ° = −0.44 |

As shown in FIG. 2e, in embodiments in which the precursor reduces during the second thermal treatment, the elimination of the first thermal treatment can result in multiple nanoparticles being formed in a single printed feature, as precursor aggregation does not occur prior to particle formation.

FIG. 3a provides a schematic illustration of the three pathways along with the x-ray photoelectron spectroscopy (XPS) images demonstrating formation of the nanoparticle along a given pathway. Table 2 below provides a listing of various decomposition pathways for precursor materials.

TABLE 2
Decomposition Pathways

| | Decomposition | |
|---|---|---|
| Nanostructure | Temperature | |
| Precursor | (° C.) | Decomposition Pathway |
| H₂PtCl₆ | ~220-510 | H₂PtCl₆→PtCl₄→PtCl_{3.5} |
| | | →PtCl₂→Pt |
| Na₂PdCl₄ | ~105 | Na₂PdCl₄ →Pd |
| AgNO₃ | ~440 | AgNO₃→Ag |
| Fe(NO₃)₃•9H₂O | ~156 | Fe(NO₃)₃•9H₂O→Fe(OH)(NO₃)₂ |
| | | →Fe(OH)₂NO₃→FeOOH→α-Fe₂O₃ |
| Co(NO₃)₂•6H₂O | ~180 | Co(NO₃)₃•6H₂O→Co(NO₃)₃•4H₂O |
| | | →Co(NO₃)₂→Co₂O₃ |
| Ni(NO₃)₂•6H₂O | ~250-300 | Ni(NO₃)₂•6H₂O→Ni(NO₃)₂•2H₂O |
| | | →Ni(NO₃)(OH)₂•H₂O |
| | | →Ni(NO₃)(OH)_{1.5}O_{0.25}•H₂O |
| | | →Ni₂O₃→Ni₃O₄→NiO |
| Cu(NO₃)₂•3H₂O | ~200-250 | Cu(NO₃)₂•3H₂O →Cu₂(OH)₃NO₃ |
| | | →CuO |

FIG. 3b (left panel) provides XPS data for representative precursors for each pathway. For example, the XPS data in FIG. 3b illustrates the formation of Au particles via pathway 1. The Au 4f_{7/2} peak for the HAuCl₄ salt precursor ink examined in FIG. 3b is at 84.9 eV, which is within the expected range for Au¹. The partial reduction illustrated in FIG. 3b prior to heat treatment may be attributed to either the reduction by PEO or by photoreduction during the measurement. After the first thermal treatment Δ1 at temperature T_{low}, the Au 4f_{7/2} peak shifts to 83.8 eV, indicating that the Au precursor has been reduced further by PEO. This peak lies slightly lower in energy than expected for bulk gold (84.0 eV), which may be attributed to the presence of electron-donating surface ligands from the PEO. This effect and shift in energy has been noted for gold nanoparticles suspended in electron-donating surface ligands (26). After performing the first thermal treatment Δ2 and thermal decomposition at T_{high}, the positions of the Au 4f peaks shift slightly higher in energy to match those of bulk gold.

Metals with slightly lower reduction potentials, such as Pt and Pd, follow reduction Pathway 2 (FIG. 3b, middle panel). In the case of Pt, for both the precursor containing ink (prior to the first thermal treatment) and after the first thermal treatment at T_{low}, the Pt 4f_{7/2} peak lies in the range for Pt^{II}, which may be attributed either to reduction by PEO or in-situ photoreduction. XPS reveals that the Pt^{II} has been fully reduced to Pt⁰ after performing the second thermal treatment at T_{high}, as indicated by the shift in energy of the Pt 4f_{7/2} peak to 70.9 eV, which closely matches that of metallic Pt. This pathway was also corroborated by ex-situ TEM (FIG. 4).

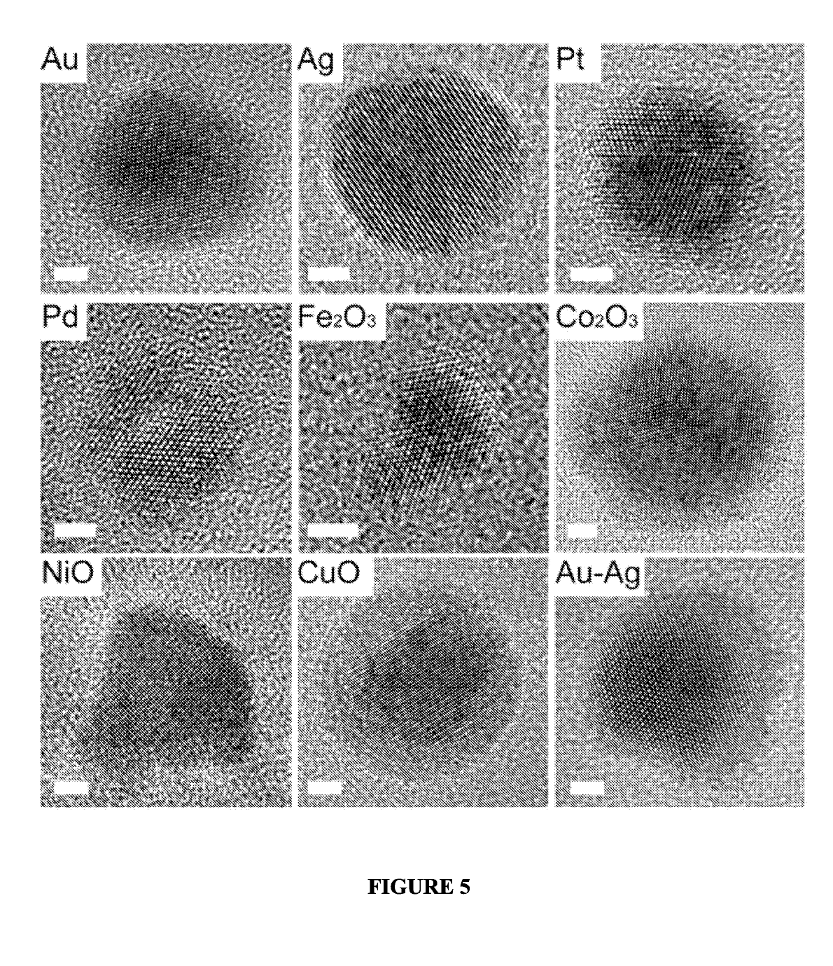

Metals with a much lower reduction potential, such as Fe, follow Pathway 3 (FIG. 3b, right panel). The XPS spectra for both the precursor containing ink (prior to the first thermal treatment) and after performing the first thermal treatment at T_{low} showed that the Fe 2p_{3/2} peak was about 709-710 eV, which is consistent with mixed oxides of iron (27). After the second thermal treatment is performed, the Fe 2p_{3/2} peak shifted in energy to 712.3 eV, which may be attributed to the formation of Fe₂O₃ (27). This was confirmed by HRTEM (FIG. 5).

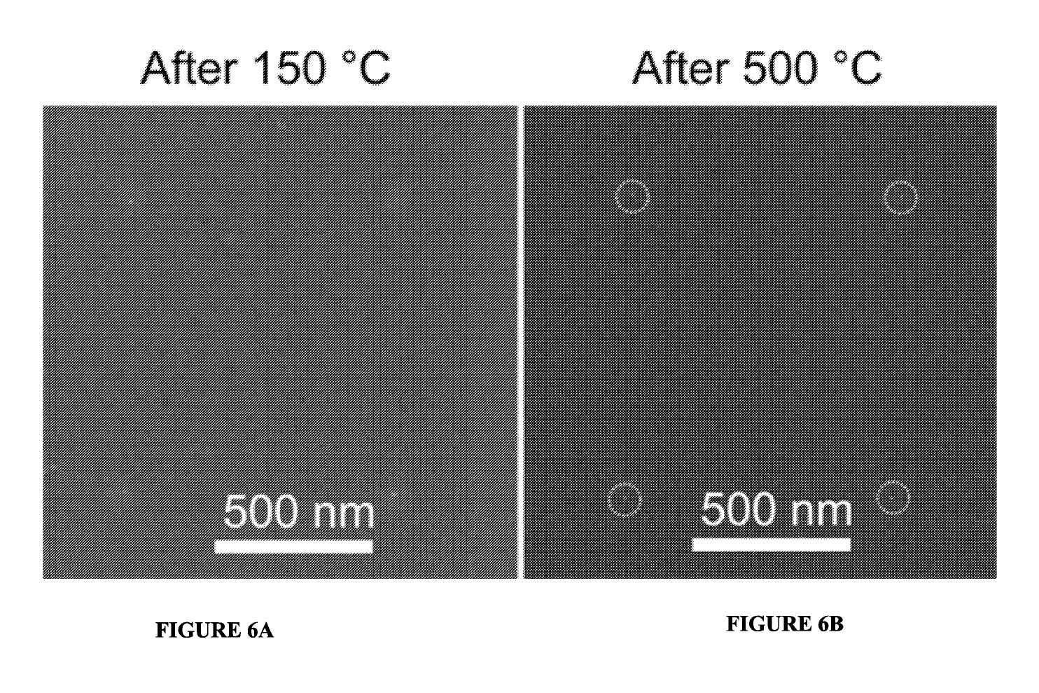

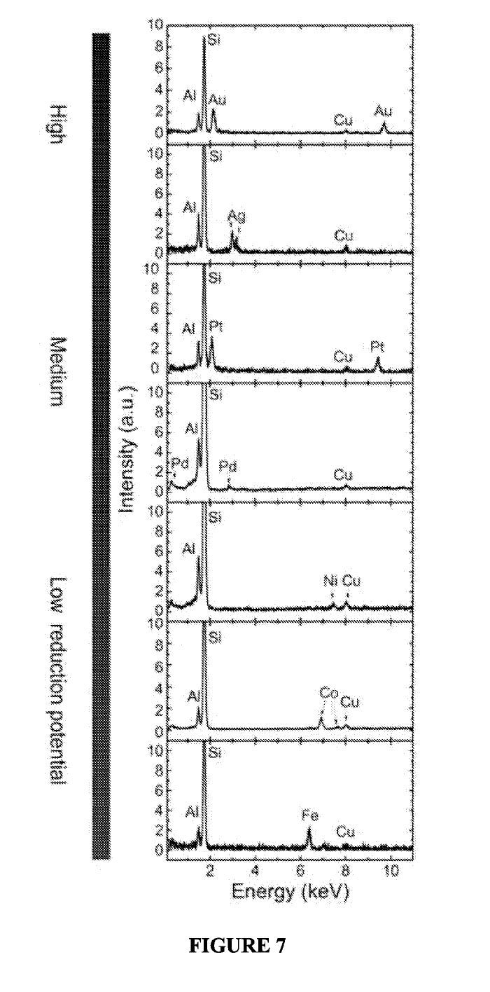

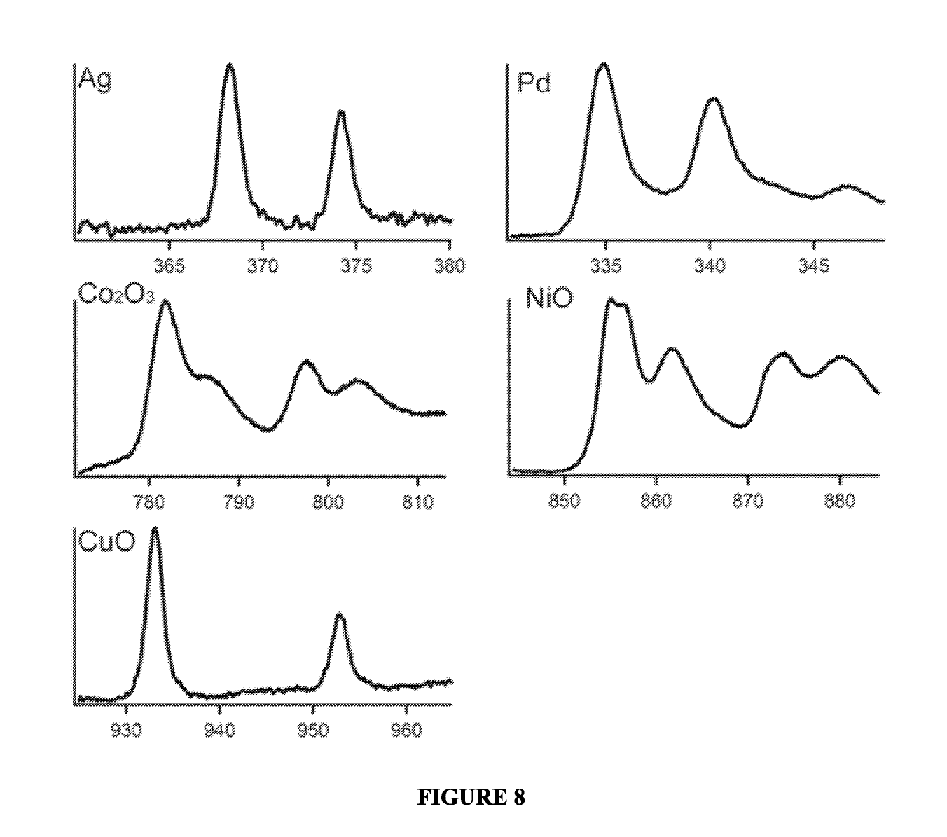

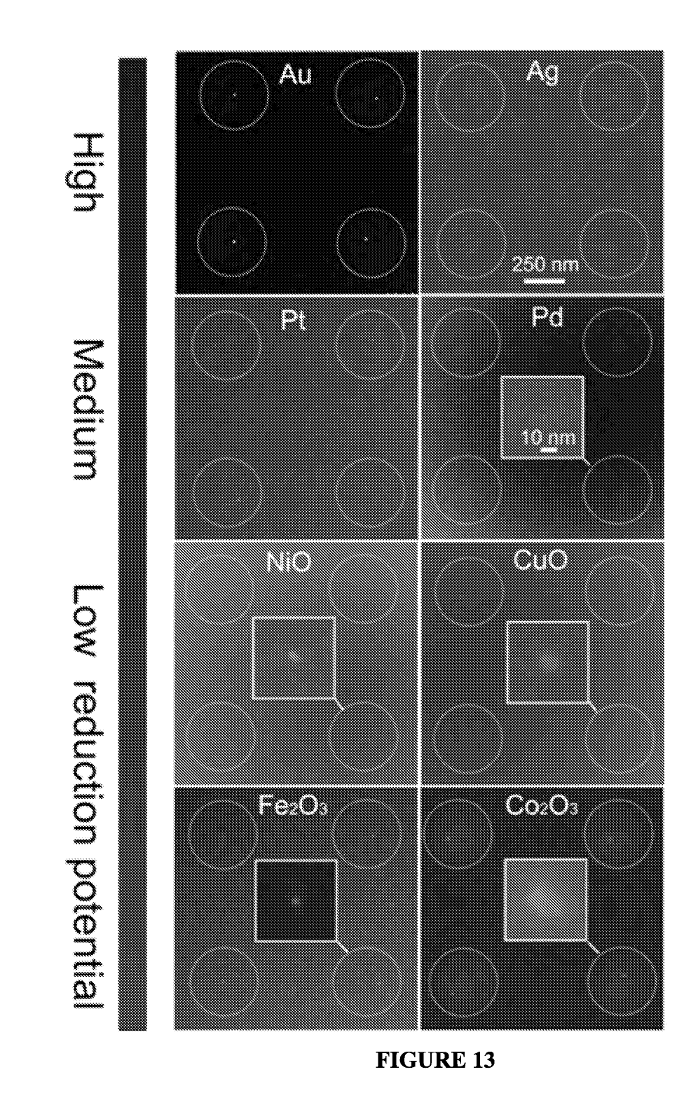

The method of the disclosure advantageously allows for the formation of nanoparticles from a block-copolymer nanostructure precursor ink or printed feature using the first and second thermal treatments, despite the mechanism by which particle formation is achieved. FIG. 13 illustrates representative STEM images for nanoparticle formulation using the methods of the disclosure for high and low reduction potential materials. For example, Ag, like Au forms particles via pathway 1 (FIG. 6). The precursor materials for materials proceeding via pathway 1 are reduced easily and can migrate even after reduction at T_{low}. Pd nanoparticles, like Pt, form via pathway 2. Pd is not very mobile in the reduced state and, therefore, ion aggregation must occur prior to reduction to avoid the generation of multiple nucleation sites and many particles within one polymer feature. Co, Ni, and Cu, like Fe, form oxide nanoparticles via pathway 3. The precursors of such nanoparticles must aggregate before the second thermal treatment at T_{high}, which facilitates oxide formation and polymer decomposition. As illustrated in FIG. 4, the crystallinity and composition of the synthesized nanoparticles was verified by HRTEM images. FIGS. 7 and 8, illustrate EDS and XPS images further confirming the nanoparticle synthesis. In FIG. 7, the Si signal is from the silicon nitride membrane. Al and Cu signals are from the TEM sample holder. Since a Cu signal is always present in the background, an EDX spectrum of Cu-containing nanoparticles is not shown. FIG. 8 illustrates XPS spectra of nanoparticles composed of Ag, Pd, Co₂O₃, NiO, and CuO. All core element peak positions in FIG. 8 fall within the expected range for the listed compositions, and all compositions were corroborated with results from HRTEM (FIG. 4). Many of the particles formed via pathway 3 exist as metal oxides under ambient conditions. Further annealing of the metal oxide nanoparticles in a reducing atmosphere can be performed to obtain metal nanoparticles.

The method can be further used to form alloy nanoparticles by blending precursors in the ink. For example, 1:1 alloys were formed by loading Ag⁺ and Au³⁺ precursors in the polymer in a 1:1 molar ratio. Any suitable blending ratios between 0 and 1 can be used depending on the alloy structure to be formed.

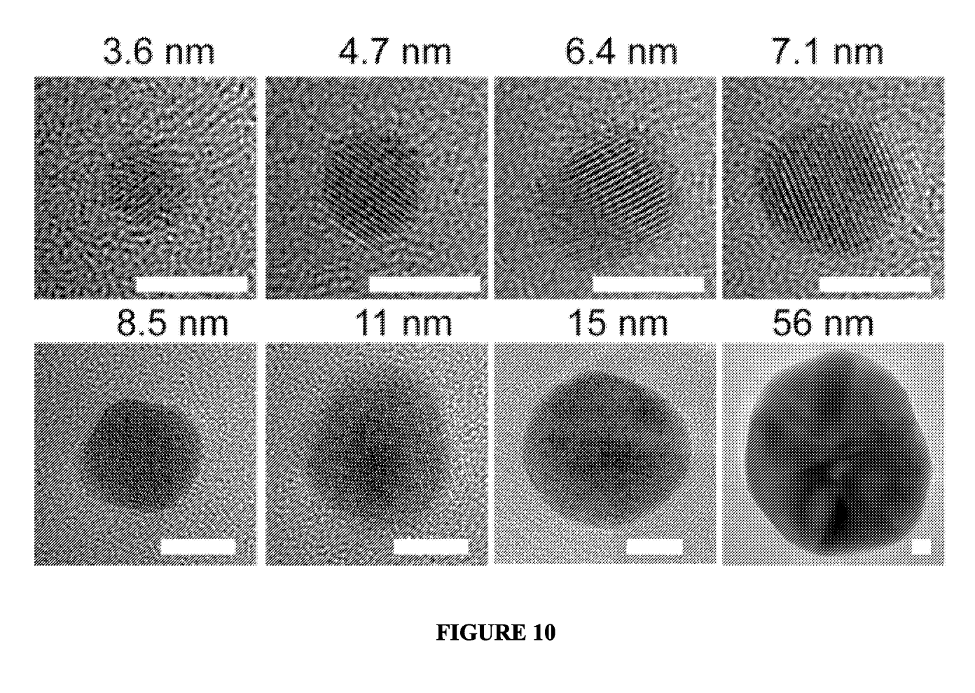

The size of the nanostructures synthesized by a method in accordance with embodiments of the disclosure can be controlled, for example, by controlling the volume of the patterned block copolymer containing features and the loading concentration of the nanostructure precursor. For example, increasing the loading concentration of the nanostructure precursor results in nanostructures having an increased size. Additionally, without intending to be bound by theory, it is believed that increasing the molecular weight of the copolymer block results in a larger micelle cores, and hence, larger structures. The structure precursor determines the local concentration of ions within the polymer micelle. The lower the concentration, the small the synthesized nanostructures. FIG. 10, for example, illustrates control of the size of gold nanoparticles in a size range between 3.6 nm and 56 nm by varying the concentration of the gold precursor in the block copolymer-nanostructure precursor ink in a range of about 4:1 to about 256:1 (block copolymer:precursor ink).

The dwell time (also referred to herein as the tip-substrate contact time) during patterning of the block copolymer-nanostructure precursor inks can be about 0.01 seconds to about 30 seconds, about 0.01 second to about 10 seconds, about 0.05 seconds to about 8 seconds, about 0.1 seconds to about 6 seconds, about 0.5 seconds to about 4 seconds, about 1 second to about 2 seconds, about 10 seconds to about 30 seconds, about 8 seconds to about 26 seconds, about 6 seconds to about 24 seconds, about 15 seconds to about 20 seconds, or about 10 seconds to about 15 seconds. Other suitable dwell times includes, for example, about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, and 30 seconds.

The size of the nanostructures synthesized by a method in accordance with embodiments of the disclosure can also be controlled by varying the dwell time when patterning by DPN or polymer pen lithography methods. The feature size dependence on tip-substrate contact time (dwell time) exhibited when using DPN or polymer pen lithography methods can be used to control both the size of the printed feature (having the block copolymer and the nanostructure precursor) and the size of the resulting nanostructure. For example, nanostructures synthesized using a method in accordance with embodiments of the disclosure and patterned by DPN can have a diameter that is linearly dependent on the square root of the tip-substrate contact time (dwell time).

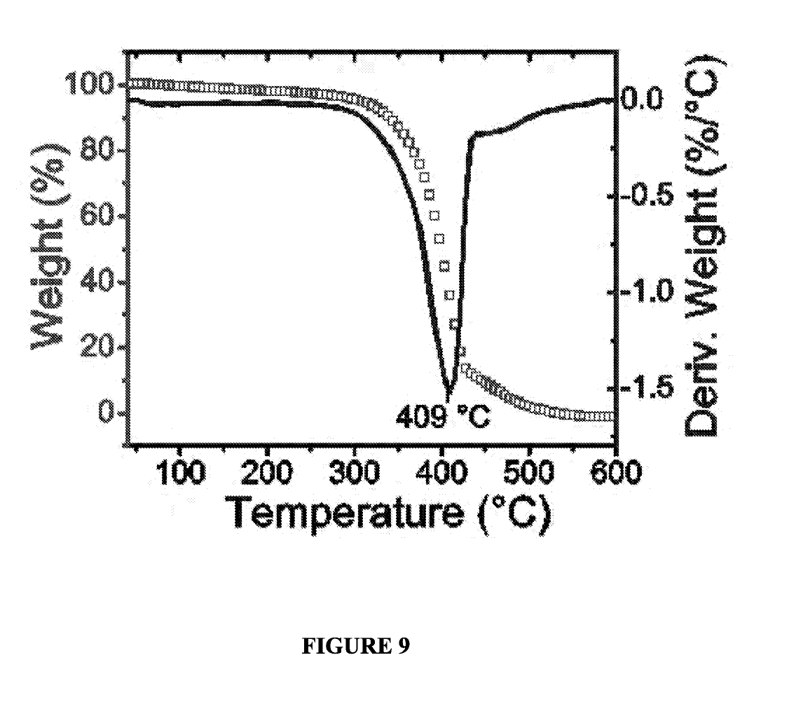

In an exemplary embodiment, metal precursors are mixed with an aqueous solution of the block copolymer poly(ethylene oxide)-block-poly(2-vinyl pyridine) (PEO-b-P2VP) and then cast onto arrays of DPN tips. The tips are mounted onto an AFM and subsequently brought into contact with hydrophobic surfaces to deposit the block copolymer loaded with metal precursors at selected sites, yielding large arrays of uniform, domed features that serve as nanoreactors for nanoparticle synthesis in later steps (FIGS. 2a, b). After patterning, the metal precursors are homogenously distributed in the polymer nanoreactors, as evidenced by uniform contrast as viewed by scanning electron microscopy (SEM). To effect metal ion aggregation without reduction, the substrate with the nanoreactors was heated to T_{low}=150° C. in a tube furnace under a flow of Ar. This temperature is above the glass transition temperature of the polymer (T_{g}=−76° C. and 78° C. for PEO and P2VP, respectively, Polymer Source, Inc.), but below its decomposition temperature (T_{d}^{p}=409° C., FIG. 9).

Generally, after aggregation of the precursor at T_{low}, a high temperature annealing step at T_{high}=500° C. is performed to decompose the polymer matrix and form the nanoparticle. By annealing at a temperature T_{high} that is above the thermal decomposition temperature T^{S}_{d} of the metal salt precursor, the precursor decomposes and forms metal nanoparticles. In some embodiments, such as when Au and Ag ions are present in the ink, continued heating at 150° C. results in metal ion reduction and formation of a nanoparticle. Phase separation during the previous step concentrates the precursors into a single region, enabling the formation of a single nanoparticle in each spot. This process also decomposes the polymer, thereby removing the majority of the organic material.

In the foregoing described exemplary embodiments, block copolymer poly(ethylene oxide)-block-poly(2-vinyl pyridine) (PEO-b-P2VP, Mn=2.8-b-1.5 kg·mol-1, polydispersity index, PDI=1.11) was purchased from Polymer Source, Inc. and used as received. The glass transition temperatures Tg for PEO and P2VP of the block copolymer are −76° C. and 78° C., respectively (Polymer Source, Inc.). Metal precursor compounds, HAuCl₄.3H2O, AgNO₃, H₂PtCl₆.6H₂O, Na₂PdCl₄, Fe(NO₃)₃.9H2O, Co(NO₃)₂.6H2O, Ni(NO₃)₂.6H2O, and Cu(NO₃)₂.3H₂O, were purchased from Sigma-Aldrich, Inc. HCl and HNO₃ were purchased from Sigma-Aldrich and diluted before use. Hexamethyldisilazane (HMDS) and hexane were purchased from Sigma-Aldrich and used as received. DPN® pen arrays (Type M, no gold-coating) were purchased from Nanoink, Inc. Hydrophobic silicon nitride membranes (membrane thickness=15 nm or 50 nm) were purchased from Ted Pella, Inc. Silicon wafers were purchased from Nova Electronic Materials.

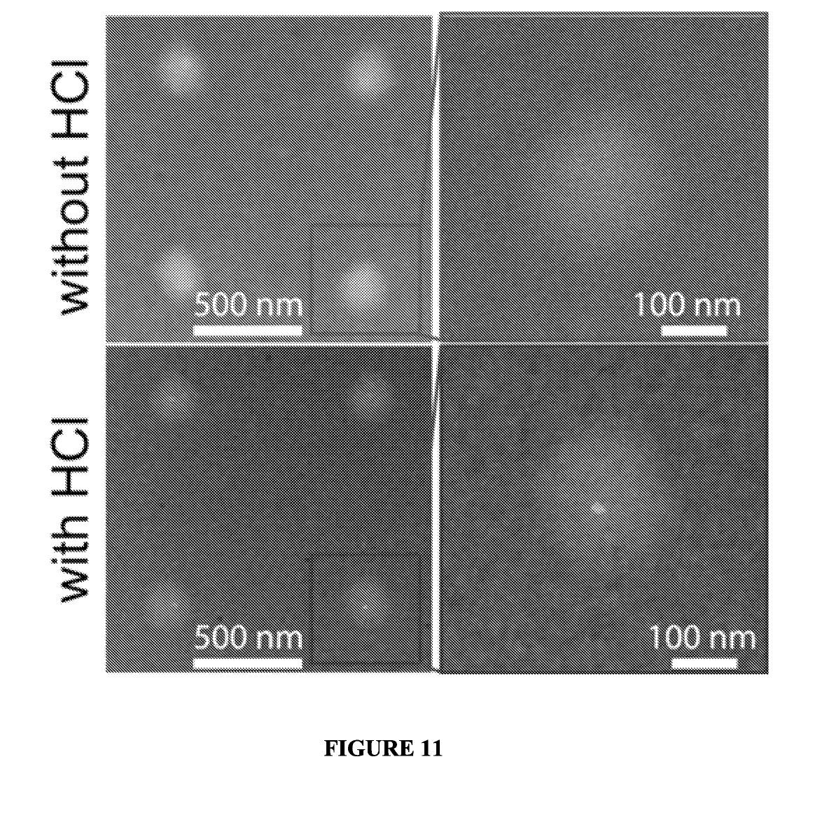

PEO-b-P2VP and metal compounds were dissolved in water, respectively. After blending the solutions of polymer and metal compound, the pH of the solution was controlled to be between 3 and 4 by adding HCl or HNO₃, for Cl⁻ or NO₃⁻ containing metal compound, respectively. FIG. 11 illustrates the effect of protonation of PEO-b-P2VP on the loading of precursors. The TEM images of FIG. 11 are patterned arrays of nanoreactors of PEO-b-P2VP on a silicon nitride window after the first thermal treatment at a temperature T_{low} of 150° C. Phase separation of Na₂PdCl₄ is only observed when HCl is mixed in the aqueous solution of PEO-b-P2VP.

In the exemplified embodiments, the final solution had a PEO-b-P2VP concentration of 5-100 mg·ml⁻¹. The ratio of 2VP:Mn+ was varied between 2:1 and 256:1 to control the size of the nanoparticles. After stirring rigorously overnight, the solution was dip-coated onto the DPN® pen array. After drying in a nitrogen stream, the pen array was brought in contact with a substrate to generate arbitrary arrangements of printed features using an NScriptor (NanoInk, Inc.) in a chamber with controlled humidity. The relative humidity was in the range of 75%-95% to control the dimensions of polymer nanoreactors of the printed features delivered from the pen array to the substrate. Both hydrophobic silicon nitride membranes and silicon wafers treated with HMDS were used. Silicon wafers were kept in a desiccator with two vials of HMDS and hexane mixture for 24 h to ensure their hydrophobicity.

After patterning, the substrate was loaded into a tube furnace and annealed in an argon stream. The annealing conditions were programmed as follows: for the first thermal treatment the furnace was ramped to 150° C. in 1 h, soak at a temperature T_{low} of 150° C. for 4-24 h, cool down to room temperature in 1 h. For the second thermal treatment the furnace was ramped to 500° C. in 1 h, soak at a temperature T_{high} of 500° C. for 2-4 h, and cool down to room temperature in 1 h. The soaking time of the first and second thermal treatments was varied to ensure full phase separation between the metal compound and the polymer at 150° C. and full decomposition of all materials at 500° C., respectively.

Atomic Force Microscopy (AFM): AFM measurements were performed on a Dimension Icon (Bruker, Inc.) to obtain three-dimensional profiles of the patterned nanoreactors, which were delivered on a surface using dip-pen nanolithography.

Scanning Electron Microscopy (SEM) and Energy-Dispersive X-ray spectroscopy (EDX): Samples prepared on hydrophobic silicon wafers were imaged with a Hitachi S-4800 SEM at an acceleration voltage of 5 kV and a current of 20 μA. Probe current was set to high, and focus mode was set to ultrahigh resolution (UHR). Only the upper second electron detector was used. To determine the elemental composition, INCA (Oxford Instruments INCA 4.15) was used to obtain EDX spectra.

Scanning Transmission Electron Microscopy (STEM), High Resolution Transmission Electron Microscopy (HRTEM) and EDX: After annealing, samples prepared on 50-nm-thick silicon nitride membranes were imaged with a Hitachi STEM HD-2300A in Z-contrast mode at an acceleration voltage of 200 kV and a current of 78 μA. EDX spectra were obtained with Thermo Scientific NSS 2.3. Samples prepared on 15-nm-thick silicon nitride membranes were imaged with a JOEL 2100F at an acceleration voltage of 200 kV.

Thermogravimetric Analysis (TGA): The polymer decomposition temperature was measured on a TGA/DSC (Mettler Toledo International Inc.) by heating from room temperature to 600° C. at a ramping rate of 10° C./min. The measurement was performed under an N₂ atmosphere.

X-ray Photoelectron Spectroscopy (XPS): To monitor the reduction of metal compounds, aqueous solutions of PEO-b-P2VP with the corresponding metal compound were drop-cast on silicon wafers. After annealing at 150° C. and 500° C., the samples were loaded into a vacuum chamber for XPS measurement (Omicron, ESCA probe).

The foregoing describes and exemplifies aspects of the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

All patents, publications and references cited herein are hereby fully incorporated by reference. In case of conflict between the present disclosure and incorporated patents, publications and references, the present disclosure should control.

### REFERENCES

1 Liu, N., Tang, M. L., Hentschel, M., Giessen, H. & Alivisatos, A. P. Nanoantenna-enhanced gas sensing in a single tailored nanofocus. Nature Mater. 10, 631-636 (2011).
2 Shipway, A. N., Katz, E. & Willner, I. Nanoparticle Arrays on Surfaces for Electronic, Optical, and Sensor Applications. Chem. Phys. Chem. 1, 18-52 (2000).
3 Kraus, T. et al. Nanoparticle printing with single-particle resolution. Nature Nanotech. 2, 570-576 (2007).
4 Huang, L. et al. Matrix-Assisted Dip-Pen Nanolithography and Polymer Pen Lithography. Small 6, 1077-1081 (2010).
5 Rycenga, M. et al. Controlling the Synthesis and Assembly of Silver Nanostructures for Plasmonic Applications. Chem. Rev. 111, 3669-3712 (2011).
6 Nelayah, J. et al. Mapping surface plasmons on a single metallic nanoparticle. Nature Phys. 3, 348-353 (2007).
7 Cheng, W., Park, N., Walter, M. T., Hartman, M. R. & Luo, D. Nanopatterning self-assembled nanoparticle superlattices by moulding microdroplets. Nature Nanotech. 3, 682-690 (2008).
8 Kim, H. et al. Parallel patterning of nanoparticles via electrodynamic focusing of charged aerosols. Nature Nanotech. 1, 117-121 (2006).
9 Huang, J., Kim, F., Tao, A. R., Connor, S. & Yang, P. Spontaneous formation of nanoparticle stripe patterns through dewetting. Nature Mater. 4, 896-900 (2005).
10 Martin, C. P. et al. Controlling pattern formation in nanoparticle assemblies via directed solvent dewetting. Phys. Rev. Lett. 99 (2007).
11 Hung, S.-C. et al. Dip Pen Nanolithography of Conductive Silver Traces. J. Phys. Chem. C 114, 9672-9677 (2010).
12 Murray, C. B., Kagan, C. R. & Bawendi, M. G. Synthesis and characterization of monodisperse nanocrystals and close-packed nanocrystal assemblies. Annu. Rev. Mater. Sci. 30, 545-610 (2000).
13 Shevchenko, E. V., Talapin, D. V., Kotov, N. A., O'Brien, S. & Murray, C. B. Structural diversity in binary nanoparticle superlattices. Nature 439, 55-59 (2006).
14 Redl, F. X., Cho, K. S., Murray, C. B. & O'Brien, S. Three-dimensional binary superlattices of magnetic nanocrystals and semiconductor quantum dots. Nature 423, 968-971 (2003).
15 Chai, J. et al. Scanning probe block copolymer lithography. Proc. Natl. Acad. Sci. USA. 107, 20202-20206 (2010).
16 Giam, L. R. et al. Positionally Defined, Binary Semiconductor Nanoparticles Synthesized by Scanning Probe Block Copolymer Lithography. Nano Lett. 12, 1022-1025 (2012).
17 Bates, F. S. & Fredrickson, G. H. Block Copolymers—Designer Soft Materials. Physics Today 52, 32 (1999).
18 Piner, R. D., Zhu, J., Xu, F., Hong, S. H. & Mirkin, C. A. “Dip-pen” nanolithography. Science 283, 661-663 (1999).
19 Chai, J., Wong, L. S., Giam, L. & Mirkin, C. A. Single-molecule protein arrays enabled by scanning probe block copolymer lithography. Proc. Natl. Acad. Sci. USA. 108, 19521-19525 (2011).
20 Chai, J., Liao, X., Giam, L. R. & Mirkin, C. A. Nanoreactors for Studying Single Nanoparticle Coarsening. J. Am. Chem. Soc. 134, 158-161 (2011).
21 Javey, A. & Dai, H. Regular Arrays of 2 nm Metal Nanoparticles for Deterministic Synthesis of Nanomaterials. J. Am. Chem. Soc. 127, 11942-11943 (2005).
22 Kiene, M., Strunskus, T., Peter, R. & Faupel, F. Evidence of Aggregation-Induced Copper Immobilization During Polyimide Metallization. Adv. Mater. 10, 1357-1360 (1998).
23 Thran, A., Strunskus, T., Zaporojtchenko, V. & Faupel, F. Evidence of noble metal diffusion in polymers at room temperature and its retardation by a chromium barrier. Appl. Phys. Lett. 81, 244-246 (2002).
24 Sakai, T. & Alexandridis, P. Single-Step Synthesis and Stabilization of Metal Nanoparticles in Aqueous Pluronic Block Copolymer Solutions at Ambient Temperature. Langmuir 20, 8426-8430 (2004).
25 Fong, Y.-Y. et al. Photoreduction Kinetics of Sodium Tetrachloroaurate under Synchrotron Soft X-ray Exposure. Langmuir 27, 8099-8104 (2011).
26 Tsunoyama, H., Ichikuni, N., Sakurai, H. & Tsukuda, T. Effect of Electronic Structures of Au Clusters Stabilized by Poly(N-vinyl-2-pyrrolidone) on Aerobic Oxidation Catalysis. J. Am. Chem. Soc. 131, 7086-7093 (2009).
27 Poulin, S., Franca, R., Moreau-Belanger, L. & Sacher, E. Confirmation of X-ray Photoelectron Spectroscopy Peak Attributions of Nanoparticulate Iron Oxides, Using Symmetric Peak Component Line Shapes. J. Phys. Chem. C 114, 10711-10718 (2010).
28 Nedelcu, M. et al. Fabrication of Sub-10 nm Metallic Lines of Low Line-Width Roughness by Hydrogen Reduction of Patterned Metal-Organic Materials. Adv. Funct. Mater. 20, 2317-2323 (2010).

1. A method for forming a structure on a substrate surface, comprising:
contacting a substrate with a tip coated with a composition comprising a block copolymer and a structure precursor to form a printed feature comprising the block copolymer and the structure precursor on the substrate;
heating the printed feature to a temperature below a decomposition temperature of the block copolymer to aggregate the structure precursor and form a structure precursor aggregated printed feature; and
heating the structure precursor aggregated printed feature to a temperature above the decomposition temperature of the structure precursor to decompose the polymer, thereby forming the structure.

2. The method of claim 1, comprising contacting the substrate with a tip array comprising a plurality of tips, with each tip being coated in an ink.

3. The method of claim 2, wherein the plurality of tips are coated in a combinatorial set of inks.

4. The method of claim 1, wherein the tip is a tip for dip pen nanolithography.

5. The method of claim 1, wherein the tip or each tip of the plurality of tips is disposed on a cantilever.

6. The method of claim 1, wherein the tip is an atomic force microscope tip.

7. The method of claim 1, comprising contacting the substrate with at least one tip from a tip array comprising a plurality of tips fixed to a common substrate layer, the tips and the common substrate layer being formed from an elastomeric polymer or elastomeric gel polymer, and the tips having a radius of curvature of less than about 1 μm.

8. The method of claim 1, comprising contacting the substrate with the tip for a period of time of about 0.01 seconds to about 30 seconds.

9. The method of claim 1, comprising contacting the substrate for a first contacting period of time and further comprising moving the tip, the substrate, or both, and repeating the contacting step for a second contacting period of time.

10. The method of claim 8, wherein the first and second contacting periods of time are different.

11. The method of claim 1, wherein the printed feature comprises block copolymer matrix micelles having the structure precursor contained therein.

12. The method of claim 1, wherein the printed features have a diameter (or line width) of about 20 nm to about 1000 nm.

13. A method of forming a structure on a substrate surface, comprising:
heating a substrate comprising a composition comprising a block copolymer and a structure precursor to a temperature below the decomposition temperature of the block copolymer to aggregate the structure precursor to form a structure precursor aggregated composition; and
heating the structure precursor aggregated composition to a temperature above the decomposition temperature of the structure precursor to decompose the polymer and form the structure.

14. The method of claim 12, comprising applying the composition comprising the block copolymer and the structure precursor under conditions sufficient to allow phase separation of the block copolymer.

15. The method of claim 13, comprising applying the composition comprising the block copolymer and the structure precursor to a substrate by micro contact printing.

16. The method of claim 13, comprising applying the composition comprising the block copolymer and the structure precursor to the substrate by one or more of dip coating, spin coating, vapor coating, spray coating, and brushing.

17. The method of claim 1, wherein the structure has a diameter (or line width) of less than 10 nm.

18. The method of claim 1, wherein the structure has a diameter (or line width) of less than 5 nm.

19. The method of claim 1, wherein the block copolymer matrix is selected from the group consisting of PEO-b-P2VP, PEO-b-P4VP, and PEO-b-PAA.

20. The method of claim 1, wherein the block copolymer comprises a first polymer for concentrating the structure precursor and a second polymer to facilitate ink transport.

21. The method of claim 1, wherein structure precursor comprises a metal salt.

22. The method of claim 20, wherein the metal salt comprises a metal selected from the group consisting of gold, silver, platinum, palladium, iron, cadmium, cobalt, nickel, copper, and combinations and metal alloys thereof.

23. The method of claim 1, wherein the structure precursor is selected from the group consisting of HAuCl₄, AgNO₃, H₂PtCl₆, Na₂PdCl₄, Fe(NO₃)₃, Co(NO₃)₂, Ni(NO₃)₂, Cu(NO₃)₂, Na₂PtCl₄, CdCl₂, ZnCl₂, FeCl₃, NiCl₂, and combinations thereof.

24. The method of claim 1, wherein the composition comprises an about 1:1 to about 256:1 molar ratio of block copolymer to structure precursor.

25. The method of claim 1, wherein the structure is a metal oxide.

26. The method of claim 1, wherein the structure is a metal nanoparticle.

27. The method of claim 1, wherein the structure is a metal alloy nanoparticle.

28. The method of claim 1, wherein the structure is a single nanoparticle.

29. The method of claim 1, comprising heating the printed feature or the substrate comprising the composition comprising the block copolymer and structure precursor for about 2 hours to about 24 hours.

30. The method of claim 1, comprising heating the structure precursor aggregated printed feature or the structure precursor aggregated composition for about 2 hours to about 10 hours.

31. The method of claim 1, comprising heating the printed feature or the substrate comprising the composition comprising the block copolymer and the structure precursor at a rate of about 1° C./min to about 10° C./min.

32. The method of claim 1, comprising heating the printed feature or the substrate comprising the composition comprising the block copolymer and the structure precursor to a temperature above a glass transition temperature of the block copolymer and below a decomposition temperature of the block copolymer.

33. The method of claim 1, comprising heating the nanostructure precursor aggregated printed feature to a temperature above the decomposition temperature of the nanostructure precursor to decompose the polymer and below a melting temperature of the structure to be formed.
